(19) United States
(12) Patent Application Publication
(10) Pub. No.: US 2006/0097426 A1
(43) Pub. Date: May 11, 2006

(54) Method of forming nubs on a composite part

(76) Inventors: Richard A. Luepke, Fort Worth, TX (US); Michael L. Hestness, Fort Worth, TX (US); Jeffrey P. Langevin, Fort Worth, TX (US)

Correspondence Address: James E. Bradley;BRACEWELL & PATTERSON, LLP, P.O. Box 61389, Houston, TX, 77208-1389, US

(21) Appl. No.: 10/984,468

(22) Filed: Nov. 9, 2004

(51) Int. Cl. B29C 45/14

(52) U.S. Cl. 264/259

(57) ABSTRACT

A method of forming nubs on a composite part employs a standard forming tool. A plurality of holes are formed in a peel ply of a woven composite material pre-impregnated with uncured resin. A first side of the peel ply is placed in contact with a forming tool. A plurality of substrate layers of a composite part is placed in contact with a second side of the peel ply. Heat and pressure are applied to the peel ply and the substrate layers to cause some of the uncured resin in the peel ply and the substrate layers to flow into and fill the holes in the peel ply. After curing, the peel ply is removed from the substrate layers, leaving nubs of cured resin on one side of the substrate layer.

### BACKGROUND OF THE INVENTION

In some manufacturing techniques, composite components formed of resin and fiber are cured, then attached to another component by adhesive. The other component might be metal or another composite part. When joining the parts, it is important to maintain a desired bond line thickness between the parts. The bond line is a thin uniform clearance between the two parts to provide volume for the adhesive.

In the past, various means have been employed to provide a bond line of uniform thickness. One approach has been to form protuberances or nubs on a side of one of the parts to be joined. The heights of the nubs must be carefully controlled to provide a desired standoff between the two bonding surfaces. In one technique, the nubs are formed by machining dimples or depressions in a forming tool. The substrate layers of the composite part are laid on the forming tool and cured. Each recess creates a nub on the composite part that has the height of the recess. While workable, machining the forming tool is time consuming and expensive. For example, an aircraft may have a large number of forming tools that would have to be machined in that manner.

### SUMMARY OF THE INVENTION

In this invention, nubs are created on a substrate layer of a composite part using a conventional forming tool without any additional machined recesses. Holes are formed in a peel ply, which is a layer that temporarily attaches to the composite part during curing and is later removed. The peel ply can be a standard resin composite fabric peel ply or a non-standard material as long as the material will conform to the tool surface and withstand the curing process. The thickness of the peel ply determines the heights of the nubs. The holes in the peel ply are placed in a desired pattern and with a desired shape and width.

The peel ply is placed on a standard forming tool, then one or more substrate layers of the composite part are placed on the peel ply. The holes in the peel ply are blocked on one side by the forming tool and on the other side by the composite part substrate layers.

Resin is introduced to the holes. Preferably, the resin source comprises pre-impregnated uncured resin in the substrate layers. The peel ply could also be pre-impregnated with uncured resin. Applying heat and pressure causes the resin to flow into the holes and cure. After curing, a technician pulls the peel ply away from the cured substrate layers, exposing the nubs that are formed where the holes in the peel ply existed. The nubs provide a uniform height standoff for an adhesive bond line.

### BRIEF DESCRIPTION OF THE DRAWINGS

FIG. 1 is an exploded schematic view illustrating a peel ply, substrate layers, and a forming tool of the invention.

FIG. 2 is a schematic view, as seen along 2-2 of the peel ply employed in FIG. 1.

FIG. 3 is an enlarged schematic sectional view of the peel ply and substrate layers of FIG. 1, shown placed on the forming tool.

FIG. 4 shows the substrate layers and the peel ply layer after curing and with the peel ply in the process of being pulled from the substrate layer.

FIG. 5 is a perspective view of a composite part having nubs formed in accordance with this invention.

### DETAILED DESCRIPTION OF THE INVENTION

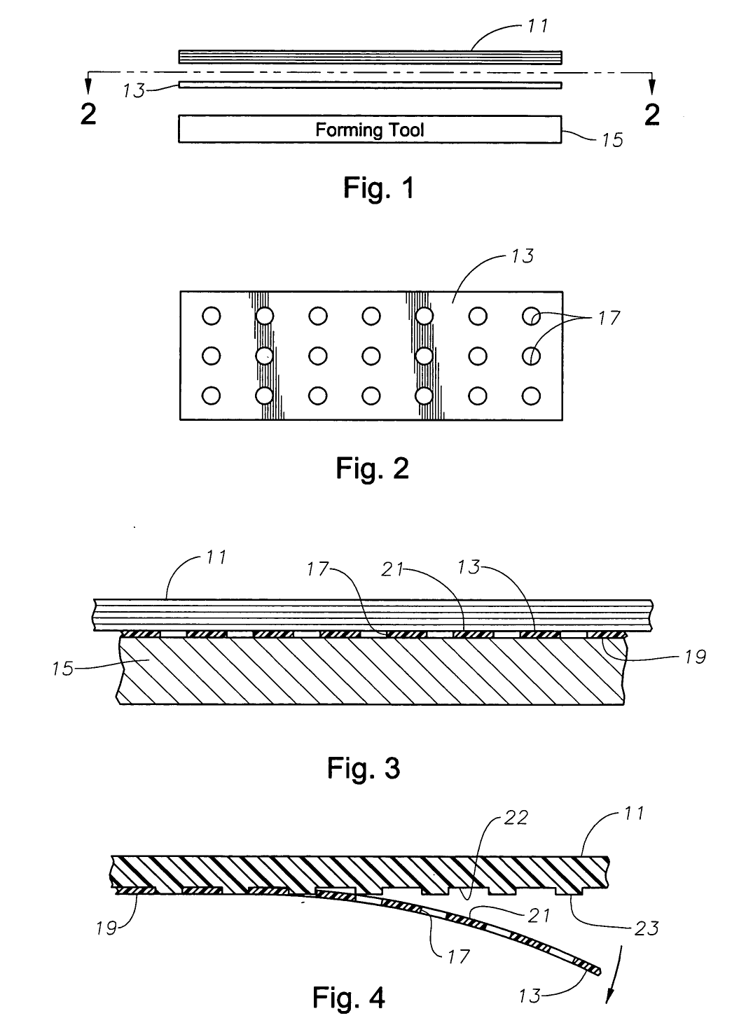

Referring to FIG. 1, a plurality of substrate layers 11 are shown above a peel ply 13, which in turn is located above a forming tool 15. Forming tool 15 is conventional and has a contour shaped to serve as a mold for a composite part. Substrate layers 11 comprise permeable conventional resin and fiber composite materials. For example, the fibers may be aramid or fiberglass fibers woven or aligned unidirectionally. There may be one of more substrate layers 11, depending upon the type of composite part to be formed. The composite part could be a variety of structures, such as a frame member or a bulkhead of an aircraft. Preferably, substrate layers 11 are pre-impregnated with a resin that is uncured, however the resin could be introduced later.

Peel ply 13 comprises a layer of a material that should be sufficiently flexible to conform to the surface of forming tool 15 and also capable of withstanding heat and pressure during a curing process. The peel ply material may be a permeable material, such as woven fiberglass, or it could be non permeable material, such as a solid plastic or acetate layer. Peel ply 13 has a uniform thickness. In one embodiment, peel ply 13 comprises woven fiberglass fabric that is pre-impregnated with a resin. Alternately, the resin could be eliminated.

Referring to FIGS. 2 and 3, peel ply 13 has a plurality of holes 17 formed in a selected pattern. In the example shown, holes 17 are in a generally rectangular pattern, but other patterns are feasible. Holes 17 are shown to be circular, but other shapes could be used, such as elliptical or polygonal. In this embodiment, the width or diameter of each hole 17 is greater than the thickness of peel ply 13. In one embodiment, each hole 17 is circular, has a diameter of about 0.125″, and is spaced from adjacent holes by 0.5″. If peel ply 13 is woven fiberglass, holes 17 are more easily formed after peel ply 13 is pre-impregnated with resin, but they could be formed prior to impregnation. Holes 17 can be formed by a punch, water jet, laser, ultrasonic device or any other means of perforation. The spacing, pattern and diameter of holes 17 can be adjusted based on the stiffness of the parts to be joined and the complexity of the contour of forming tool 15.

In the method of this operation, peel ply 13 is placed on forming tool 15. As illustrated in FIG. 3, a first side 19 is in flush contact with the forming surface of forming tool 15. One or more substrate layers 11 are then placed against a second side 21 of peel ply 13. Each hole 17 is blocked on side 19 by forming tool 15. Each hole 17 is blocked on opposite side 21 by substrate layers 11. Initially, holes 17 will be empty.

The technician then cures substrate layers 11 and peel ply 13 in a conventional manner. For example, this may be done by enclosing substrate layers 11 and peel ply 13 in a vacuum bag, evacuating the bag to create pressure, then applying heat. Other conventional curing processes could also be utilized.

During the curing process, the heat causes the resin to flow from substrate layers 11 and peel ply 13, if it is pre-impregnated, into holes 17, filling holes 17. The resin is allowed to cure, causing it to become rigid. The resin within holes 17 bonds to substrate layers 11, but not to forming tool 15.

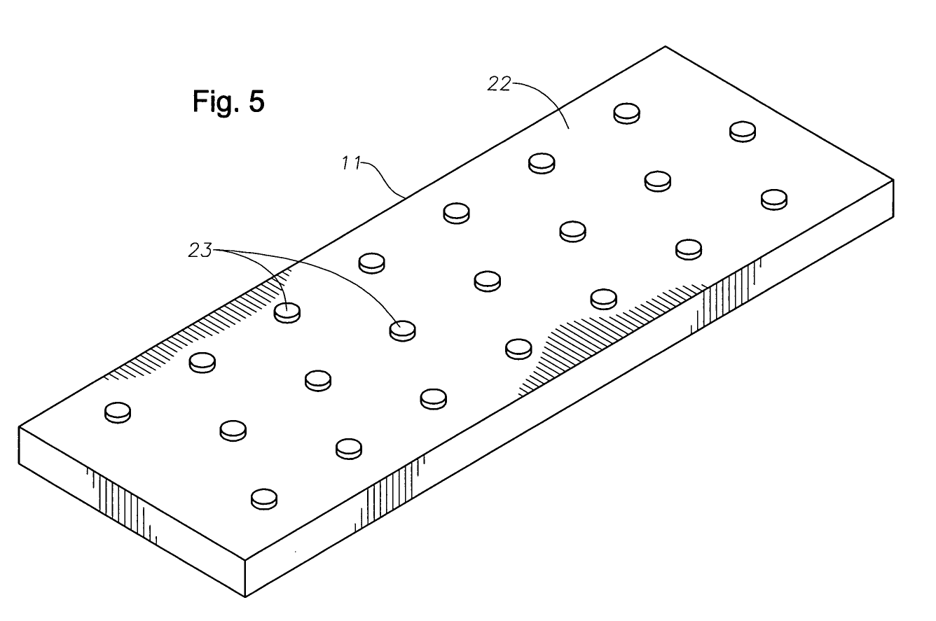

Then, the technician pulls peel ply 13 from substrate layers 11, as illustrated in FIG. 4. Even though peel ply 13 and substrate layers 11 are in contact with each other during the curing, peel ply 13 does not permanently bond to substrate layers 11 and can be peeled from substrate layers 11. Removing peel ply 13 exposes a smooth surface 22 on substrate layers 11. Nubs 23 protrude from surface 22, each nub being the cured resin that previously existed in one of the holes 17. Nubs 23 have the same standoff or height, which is equal to the thickness of peel ply 13. The thickness of peel ply 13 is selected to be the desired width of an adhesive bond line. FIG. 5 shows a portion of smooth surface 22 and nubs 23.

After peel ply 13 is removed, adhesive (not shown) is placed between surface 22 of substrate layers 11 and another component (not shown). The adhesive may be a liquid or a film. The components are forced together with pressure and the adhesive allowed to cure. The adhesive flows around nubs 23 into the spaces between surface 22 and the other component, these spaces providing the desired bond line thickness for the particular adhesive in the application.

The invention has significant advantages. The nubs provide an accurate standoff to create an adhesive bond line of uniform thickness. The nubs are readily formed on the component by using a peel ply layer. This method forms nubs less costly than the prior approach of machining recesses on the surface of the forming tool.

While the invention has been shown in only one of its forms, it should be apparent to those skilled in the art that it is not so limited but is susceptible to various changes without departing from the scope of the invention.

1. A method of forming nubs on a composite part, comprising:
(a) forming a plurality of holes in a peel ply;
(b) placing at least one substrate layer of a composite part in contact with one side of the peel ply;
(c) introducing resin in the substrate layer
(d) introducing resin into the holes in the peel ply and curing the resin within the substrate layer and in the holes; then
(e) removing the peel ply from the substrate layer, the cured resin formerly within the holes defining nubs on one side of the substrate layer.

2. The method according to claim 1, wherein step (c) comprises pre-impregnating the substrate layer with resin

3. The method according to claim 1, wherein steps (c) and (d) comprise pre-impregnating the substrate layer with resin, then applying heat and pressure, which causes the resin to flow into the holes and cures the resin.

4. The method according to claim 1, wherein step (d) comprises placing the peel ply and the substrate layer on a mold and applying heat and pressure.

5. The method according to claim 1, wherein step (a) comprises pre-impregnating the peel ply with resin, then forming the holes.

6. The method according to claim 1, wherein the peel ply of step (a) comprises a permeable material.

7. A method of forming nubs on a composite part, comprising:
(a) providing a peel ply of composite material with a plurality of holes;
(b) placing a first side of the peel ply in contact with a forming tool;
(c) overlaying at least one substrate layer for a composite part on a second side of the peel ply;
(d) introducing resin to the peel ply and to the substrate layer;
(e) causing the resin to enter the holes in the peel ply and curing the resin within the peel ply and the substrate layer; then
(f) removing the peel ply from the substrate layer to provide the composite part, the cured resin formerly within the holes defining nubs on one side of the substrate layer.

8. The method according to claim 7, wherein the composite material of the peel ply comprises a woven fabric.

9. The method according to claim 7, wherein step (a) comprises making the holes circular.

10. The method according to claim 7, wherein step (a) comprises providing the holes with widths greater than a thickness of the peel ply.

11. The method according to claim 7, wherein step (d) comprises pre-impregnating the peel ply and the substrate layer with the resin prior to steps (b) and (c).

12. The method according to claim 7, wherein step (e) comprises applying heat and pressure to the peel ply and the substrate layer.

13. A method of forming nubs on a composite part, comprising:
(a) forming a plurality of holes in a peel ply of a woven composite material pre-impregnated with uncured resin, such that the holes extend from a first side to a second side of the peel ply;
(b) placing the first side of the peel ply in contact with a forming tool, the forming tool blocking a first side end of each of the holes;
(c) placing a plurality of substrate layers of a composite part in contact with the second side of the peel ply, the substrate layers blocking a second side end of each of the holes and being pre-impregnated with uncured resin; then
(d) applying heat and pressure to the peel ply and the substrate layers to cause some of the uncured resin in the peel ply and the substrate layers to flow into and fill the holes in the peel ply, then allowing the resin to cure; then
(e) removing the peel ply from the substrate layers, the cured resin formerly within the holes defining nubs on one side of the substrate layer.

14. The method according to claim 13, wherein step (a) comprises making the holes circular.

15. The method according to claim 13, wherein step (a) comprises providing the holes with widths greater than a thickness of the peel ply.
